(19) United States
(12) Patent Application Publication
(10) Pub. No.: US 2008/0199830 A1
(43) Pub. Date: Aug. 21, 2008

(54) Iontophoresis and Active Dental Appliances

(76) Inventors: Mark G. Fontenot, Palo Alto, CA (US); Philip R. Houle, Sunnyvale, CA (US)

Correspondence Address: PETERS VERNY , L.L.P., 425 SHERMAN AVENUE, SUITE 230, PALO ALTO, CA, 94306, US

(21) Appl. No.: 12/033,827

(22) Filed: Feb. 19, 2008

Related U.S. Application Data
(60) Provisional application No. 60/902,001, filed on Feb. 16, 2007.

(51) Int. Cl. A61C 19/06; H02G 3/00; A46B 9/04; A61C 17/00

(52) U.S. Cl. 433/215; 174/70 R; 15/167.1; 433/80

(57) ABSTRACT

Dental trays, toothbrushes, and other devices are provided for the active delivery of medicaments into hard and soft tissues, particularly those of the oral cavity. The devices apply an AC voltage with a DC offset to drive medicaments into the tissues.

### CROSS-REFERENCE TO RELATED APPLICATIONS

This application claims the benefit of U.S. Provisional Application No. 60/902,001 filed on Feb. 16, 2007 and entitled “Iontophoresis and Active Dental Appliances” which is incorporated herein by reference. This application also cites Disclosure Document No. 570858 filed on Feb. 16, 2005 as a request that the Disclosure Document be retained.

### BACKGROUND OF THE INVENTION

1. Field of the Invention

The present invention relates generally to dentistry and more specifically to active administration of medicaments to hard and soft tissues.

2. Description of the Prior Art

It is a common dental practice to deliver medicaments to the dental arch and tissues of the oral cavity using a dental tray containing a desired medicament. For example, a sodium fluoride (NaF) gel is dispensed into a disposable dental tray and placed over the dental arch to remineralize the teeth and help prevent tooth decay. In some cases, a dentist will fabricate a custom dental tray specific to the patient's dental arch and teeth, while in other instances medicaments such as tooth whiteners are provided in individually packaged disposable universal dental trays. Similarly, medicaments are provided on a strip that is placed over the teeth of the dental arch to whiten teeth, for example. All of the aforementioned methods of medicament delivery are examples of passive delivery to the target site in the oral cavity. That is, the medicament is placed in direct contact with the target site and any penetration into the target site is achieved by diffusion down a concentration gradient and is limited by the permeability of the target site to the medicament.

There are a number of issues associated with the passive delivery a medicament into the dental pulp. Some medicaments such as antibiotics, glucocorticoids and nonsteroidal anti-inflammatory drugs (NSAIDs) may save the pulp in the boundary zone between reversible and irreversible pulpitis, however, when a medicament is topically applied (passive delivery) to dentin, the drug diffusion into the pulp is inhibited by an outward flow of dentinal fluid. Additionally, dentin sclerosis or reparative dentin formation following physiological or pathological stimulation results in a reduction of dentin permeability and appears to influence the drug diffusion through dentinal tubules. Even if the drugs reach the pulpal tissue, odontoblasts and pulpal microcirculation may prevent the drugs from reaching an effective concentration.

By contrast, active delivery employs a driving force to drive the medicament into the target site. Reports in the professional dental literature, for example, describe the use of iontophoresis to deliver various medicaments to the dental arch and intraoral soft tissues. Iontophoresis employs an electric field to drive ions of soluble salts into the target site. Iontophoresis has been used in dentistry to delivery a variety of ionizable medicaments including fluorides, desensitizers, steroids, anesthetics, and other drugs. Because of the anatomy of the oral cavity and of the target site (e.g., one or more teeth), a dental tray delivery configuration is often employed. Here, the tray includes a medicament and is placed over the tooth or teeth. A voltage is maintained between the tray and the target site to produce the electric field that drives ions from a medicament into enamel, dentin, and exposed cementum. A patch device that operates according to similar principles has also been used to actively delivery medicaments to soft tissues in the mouth.

With conventional iontophoresis, a power supply is used to apply a constant current, such that the flow of electrons translates into an ion flux across the oral mucosa, teeth, cementum, or dentin. It will be appreciated that components within the medicament that are not ionized will not be influenced by the electric field and different ions subject to the electric field will have different mobilities based on factors such as their charge and mass. For analytes that are bound to proteins, for instance, only the free fraction can significantly contribute to charge transport across the mucosa. In short, iontophoresis works well to deliver ions that are small, highly charged, present in high concentration, and not significantly protein-bound.

As one example, a dental tray has been used to deliver fluoride to the teeth, here, a sponge soaked with NaF is placed in a dental tray having an electrode disposed in the bottom of the dental tray. Another electrode is attached to the patient's body. The NaF dissociates into Na⁺ and F⁻ ions and under the influence of the electric field the F⁻ ions are driven away from the negatively charged tray electrode and towards and into the positively charged tooth or teeth. The DC field can be varied to improve ion mobility.

The prior art also includes a two-step ion exchange method wherein a first pre-treatment dental tray containing a metal salt solution is delivered to the teeth of the dental arch and removed after several minutes. Then, in a second step, an electrically active dental tray containing a fluoride solution is delivered to the dental arch. Electrical contacts are located on the facial surface of the electrically active dental tray, and when a voltage is applied, the electric field causes an ion exchange in the teeth such that fluoride ions are exchanged with hydroxyl ions in the enamel. This process, however, is an ion exchange process rather than iontophoresis by definition.

### SUMMARY

An exemplary system for delivering a medicament into hard or soft tissue comprises a conductive layer and a dielectric layer disposed over the conductive layer. The system also comprises an electrode and a power supply configured to apply AC with a DC offset between the conductive layer and the electrode. In some embodiments the conductive layer is patterned. The dielectric layer including openings, which in some embodiments result from the dielectric layer being patterned with the openings. One suitable material for a patterned dielectric layer is fluorinated ethylene-propylene. In other embodiments the dielectric layer comprises a hydrogel. In these embodiments the openings therein are pores or channels in the hydrogel. The electrode can comprise a metal strip or conductive adhesive patch in various embodiments. The power supply can comprise a battery.

In some embodiments, the system further comprises a dielectric substrate wherein the conductive layer is disposed between the dielectric substrate and the dielectric layer. In some of these embodiments the dielectric substrate comprises polyimide. Also in some of these embodiments the dielectric substrate comprises a dental tray. Other embodiments of the system comprise a toothbrush, where a bristle of the toothbrush comprises the conductive and dielectric layers. Still other embodiments of the system comprise an endo fie that comprises the conductive and dielectric layers.

An exemplary dental tray comprises a dielectric substrate formed to have a trough and to approximate the curvature of a dental arch, a dielectric layer conforming to the dielectric substrate and including openings, and a conductive layer disposed between the dielectric substrate and the dielectric layer. The exemplary dental tray can comprise, in some embodiments, a medicament disposed within the trough. The exemplary dental tray can also comprise a power supply configured to generate AC with a DC offset. In some of these embodiments, the power supply includes a battery. In various embodiments of the dental tray the conductive layer comprises a pattern, the dielectric layer comprises a pattern of openings, or the dielectric layer comprises a hydrogel.

An exemplary toothbrush comprises a conductive pad disposed on an exterior surface, a plurality of conductive bristles each including an electrically conductive core surrounded by a patterned dielectric layer, a battery, and a control circuit in electrical communication with the battery, the conductive pad, and the plurality of conductive bristles and configured to apply a voltage between the conductive pad and the conductive bristles. The control circuit of the toothbrush can be configured to apply DC between the conductive pad and the conductive bristles, or apply AC with a DC offset between the conductive pad and the conductive bristles.

An exemplary method for delivering a medicament into tissue comprises placing the medicament between the tissue and a conductive layer of a device and applying AC with a DC offset between the tissue and the conductive layer. In some embodiments applying AC with a DC offset between the tissue and the conductive layer includes attaching an electrode to the person being treated. Applying AC with a DC offset between the tissue and the conductive layer can include applying about 300 to 1500 mA/cm². Applying AC with a DC offset between the tissue and the conductive layer can also include applying DC current of about 0.2 mA and/or applying AC current of about 0.05 mA.

In some instances the device comprises a dental tray and placing the medicament between the tissue and the conductive layer includes placing the dental tray over a dental arch. Some of these embodiments further comprise filling a trough of the dental tray with the medicament. In other such embodiments, the dental tray includes a hydrogel layer disposed over the conductive layer and including the medicament. In other embodiments of the method, the device comprises a toothbrush and the method further comprises applying a toothpaste including the medicament to the toothbrush. The device can also comprise an endofile, the medicament comprises an agent to block nerve conduction, and the method further comprises applying the agent to a tooth.

### BRIEF DESCRIPTION OF THE DRAWINGS

FIG. 1 is a top view of an exemplary substrate for forming a dental tray.

FIG. 2 is a perspective view of the substrate of FIG. 1 at an intermediate stage of being formed into a dental tray.

FIG. 3 is a cross-sectional view of an exemplary dental dray.

FIGS. 4-6 are schematic representations of exemplary systems for applying a medicament to a tooth with a dental tray.

FIGS. 7-9 show exemplary waveforms that can be employed to apply a medicament to tissue.

FIG. 10 is a cross-sectional view of an exemplary toothbrush.

FIG. 11 is a cross-sectional view of an exemplary conductive bristle for the toothbrush of FIG. 10.

FIG. 12 is an alternative head design for the toothbrush of FIG. 10.

FIG. 13 is a schematic representation of exemplary system for applying a medicament to a tooth with an endofile.

FIG. 14 is a schematic representation of an exemplary method for applying a medicament to tissue.

FIG. 15 is a cross-sectional view of an exemplary dental dray including an integral power supply.

### DETAILED DESCRIPTION

The present disclosure is directed to the active delivery of medicaments into hard and soft tissues, particularly those of the oral cavity. Iontophoresis is employed to drive medicaments into the tissues using a DC voltage. An AC voltage can be added to the DC voltage to improve the mobility of the medicaments through the tissues. Devices for the active delivery of medicaments into hard and soft tissues are also provided, as well as methods for their use, and methods for their manufacture.

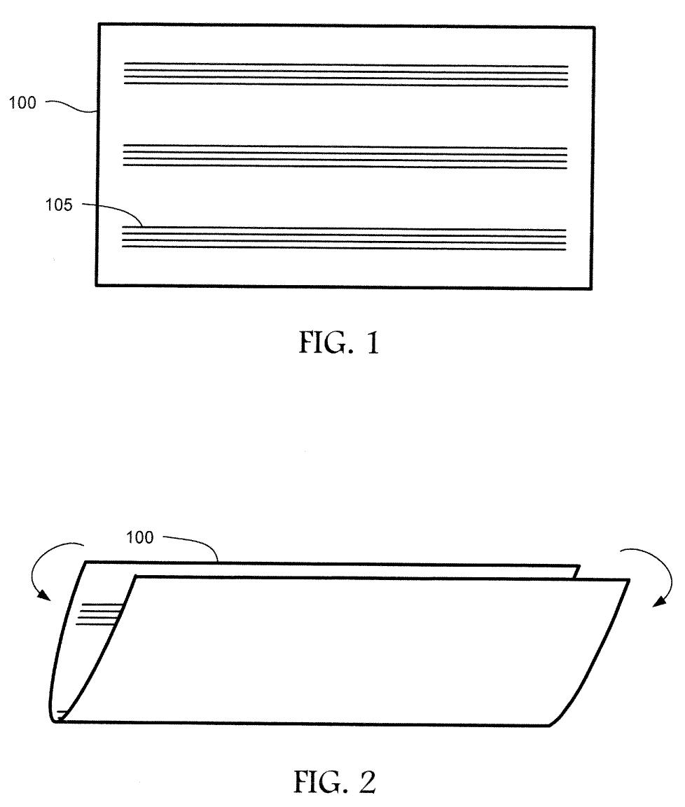

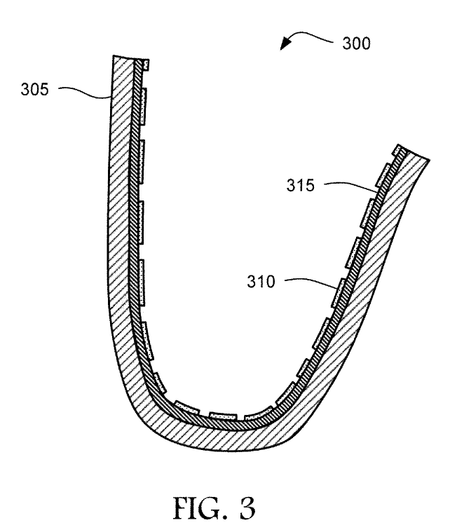

Attention is first directed to an exemplary device for the active delivery of medicaments. FIGS. 1 and 2 illustrate a method for making an exemplary dental tray. FIG. 3 shows across-sectional view of an exemplary dental tray generally made in accordance with the method represented by FIGS. 1 and 2. FIG. 1 shows a top view of a dielectric substrate 100 on which a conductive layer 105 is disposed. The substrate 100 can comprise a thermoplastic and/or thermoset polymer, for instance. One suitable polymer for the substrate 100 is polyimide. In various embodiments, the substrate 100 is both readily formable and, once formed, retains a level of pliability or flexibility sufficient to be customized to different individuals as will be described in greater detail below. The conductive layer 105 can comprise gold, carbon, platinum, silver, or copper, for example. In the embodiment illustrated by FIGS. 1 and 2, the conductive layer 105 has been patterned, for example, by conventional masking and etching of a continuous layer of the conductive layer 105. In some embodiments, the conductive layer 105 is formed by sputter coating, vapor deposition, or printing onto the substrate 100. The conductive layer 105 can be deposited over a mask on the substrate 100 so that after the mask is removed the remaining conductive layer 105 comprises a pattern. In some embodiments, the conductive layer 105 is not patterned, as described below with respect to FIG. 3.

In the example illustrated by FIGS. 1 and 2, the conductive layer 105 is patterned to form sets of parallel conductive traces. Although not shown, the traces within each set of parallel traces can be electrically joined, and the sets connected to a power supply, discussed below. In this way, the electrical voltage applied to each set of traces can be independently controlled. It will be appreciated that more complex patterns in the conductive layer 105 can be readily fabricated. In the example shown in FIG. 3, where the conductive layer 105 is not patterned, the entire conductive layer 105 will carry the same electrical potential when in use.

The conductive layer 105 can also be prepared through other methods. For example, a suspension of conductive metal particles in a conductive liquid binder, like a conductive ink, can be applied to the substrate 100, for example, using ink jet or other standard printing technologies, for example transfer printing technologies such as pad printing. Preferably, the suspension dries rapidly once it is applied to the substrate 100. Such printing techniques allow the conductive layer 105 to be patterned as described above.

The conductive layer 105 pattern can be non-linear, for example it can be in the form of a wave or zig-zag pattern. Patterning the conductive layer 105 in this fashion allows the substrate 100 to be deformed to a greater extent during a subsequent molding process, described below, without breaking the conductive layer 105 pattern. The conductive layer 105 pattern can be designed such that the pattern becomes linear or nearly linear, after deformation of the substrate 100 during the molding process.

Also not shown in FIG. 1, for clarity of illustration, is a patterned dielectric layer disposed over the conductive layer 105. As described in more detail with respect to FIG. 3, this patterned dielectric layer serves to keep the conductive layer 105 from making direct contact with the tissue to be treated, thereby preventing an electrical short.

To form the substrate 100 into the shape of a dental tray, the substrate 100 with the conductive layer 105 and patterned dielectric layer is first folded to form a trough, as shown in FIG. 2. This can be achieved, for example, by molding the substrate 100 around a mandrel. The ends of the folded substrate 100 are then brought towards one another, as indicated by the arrows in FIG. 2, until the substrate 100 approximates the curvature of a dental arch. Again, this can be achieved by molding. The ends of the substrate 100 can then be sealed closed, in some embodiments. In other embodiments, the final shape of the dental tray is created through a thermoforming process and/or plug assisted thermoforming process.

Alternatively, the substrate 100 can be molded into the final shape before other layers are added, for example through electroplating, vapor deposition and/or sputtering. In still other embodiments, the substrate 100 is molded after the conductive layer 105 has been provided as a continuous layer, but before the conductive layer 105 has been patterned. To pattern the conductive layer 105 after the substrate 100 has been molded, a process similar to pad printing can be employed. Here, an appropriate masking material is patterned in the form of the desired conductive layer 105 pattern onto a flexible mandrel that nearly matches the shape of the cavity of the molded substrate 100, for example a silicone mandrel. The mandrel is then inserted into the formed substrate 100 and pressed against the surface thereby transferring the masking material to the substrate 100. A standard etching process is then used to remove any conductive material 105 not protected by the masking material. Similarly, this masking technique can be used to form a mask directly on the substrate 100, and then a solution or suspension comprising a conductive material can be applied over the mask to form the patterned conductive layer 105.

In certain embodiments the geometry of the molded substrate 100 allows the conductive solution or suspension to be transferred from a roller, for example a silicone roller. In some of these embodiments, the conductive solution or suspension is applied to a surface of the roller away from the surface where the roller contacts the substrate 100 as the roller is moved along the substrate 100. This allows for the use of a roller small enough to fit into the molded geometry of the substrate and to apply a continuous pattern of the conductive layer 105 much longer than the circumference of the roller. In some of these embodiments, a raised pattern on the surface of the roller (or the surface of the flexible mandrel described above) can be coated with the conductive solution or suspension to transfer the pattern onto the substrate 100.

FIG. 3 shows a cross-sectional view of an exemplary dental tray 300. The dental tray 300 comprises an outer dielectric layer 305 formed from the substrate 100, an inner dielectric layer 310, and a conductive layer 315 disposed between the outer and inner dielectric layers 305 and 310. If constructed from appropriate materials, the dental tray 300 can be sufficiently flexible to conform to different dental arches. While the conductive layer 315 is shown as a continuous layer in this embodiment, and described above, the conductive layer 315 can also be patterned. If the conductive layer 315 in FIG. 3 were patterned as shown for the conductive layer 105 in FIG. 1, the conductive layer 315 would comprise a number of parallel traces running perpendicular to the plane of the drawing page.

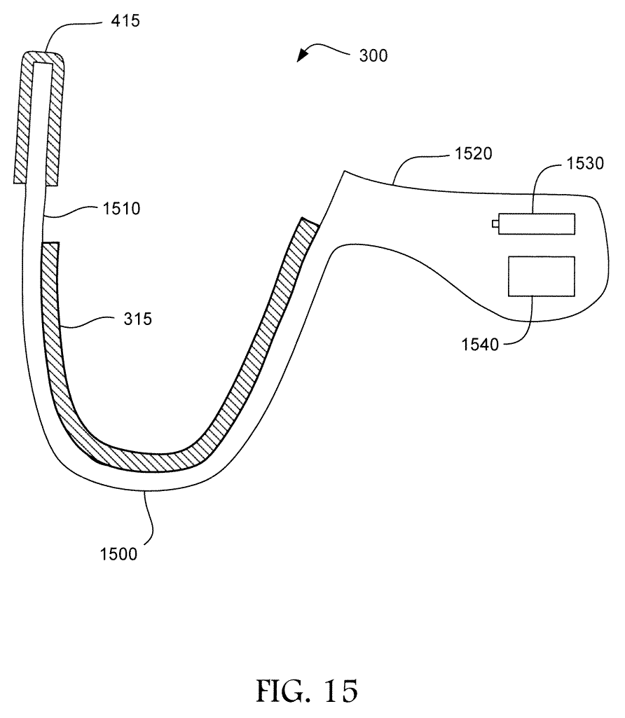

The dielectric layer 310, as noted above, serves to keep the conductive layer 315 from contacting the tissue to be treated, preventing a direct electrical short. In various embodiments, the thickness of the dielectric layer 310 is about 3 mm, about 2 mm, about 1 mm, or about 0.5 mm to provide approximately that spacing between the conductive layer 315 and the tissue being treated. The dielectric layer 310 can comprise, for example, a layer of fluorinated ethylene-propylene (FEP). In some embodiments, the dielectric layer 310 is patterned with openings through which the conductive layer 315 is exposed. Referring again to FIG. 15 in some embodiments, the dielectric layer is patterned with openings such as an array of circular holes and then fused over the conductive layer 105. In other situations the dielectric layer is first bonded over the conductive layer 105, masked, and then etched to produce a pattern of openings. The dielectric layer 310 can be formed either before or after the outer dielectric layer 305 is molded by techniques generally described above for forming the conductive layer 105.

In certain embodiments, the dielectric layer 310 comprises a hydrogel layer. The hydrogel layer can be bonded, such as by lamination, to the conductive layer 315, though it will be appreciated that the dielectric layer 310 does not have to be firmly attached to the conductive layer 315 and in some embodiments is held in place merely by van der Waals or other weak forces, or is removable. In some instances, no heat or pressure need be applied to bond the hydrogel to the conductive layer due to the inherent tackiness of the hydrogel. The hydrogel layer can include, for example, a concentration of a medicament such as a whitening agent. Hydrogels such as PVA and p-HEMA with or without the medicament can also be bonded to the conductive layer 315. In contrast to the previous embodiments, since the hydrogel layer inherently includes openings in the form of channels or pores, the hydrogel layer does not have to be patterned to include openings.

In still other embodiments the outer dielectric layer 305 can be patterned with holes to increase the rate and ease of fluid movement, for example saliva, through the dental tray 300 and into the treatment area. This fluid movement can increase the rate at which the hydrogel swells and therefore the rate at which the medicament can move from the hydrogel into the target tissue. Alternatively, the outer dielectric layer 305 can be constructed of a porous material that allows the free movement of fluid, for example saliva, through the outer dielectric layer 305 and in to the treatment area.

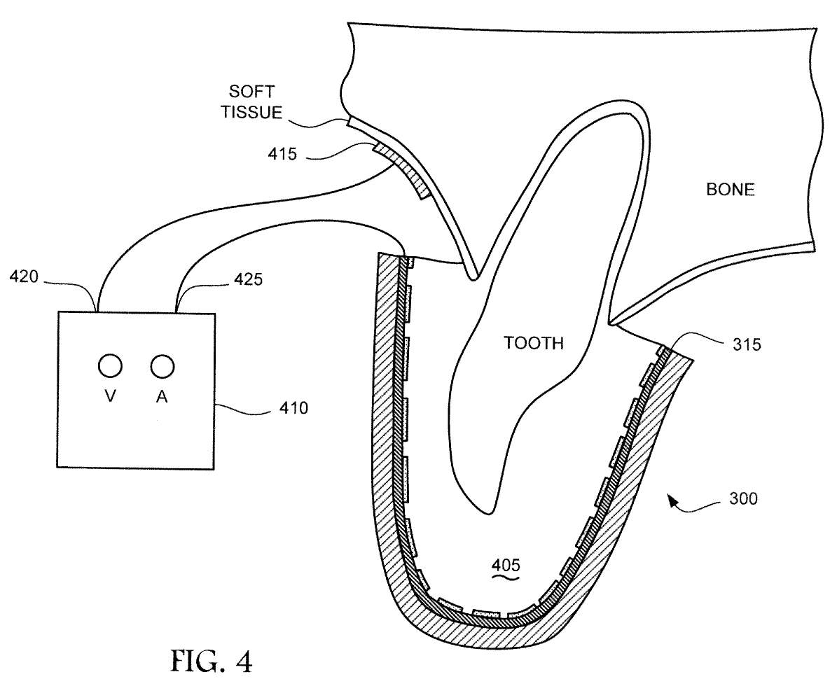

FIGS. 4-6 show various embodiments of the dental tray 300 in exemplary use configurations. In FIG. 4 the dental tray 300 is disposed proximate to a tooth and the volume between the dental tray 300 and the tooth is filled with a medicament 405 that can take the form of a gel or solution, for instance. Gels, with the exception of hydrogels, can be viscous gels with viscosities on the order of 100,000 to 1,000,000 cp. More specifically, viscosities can be on the order of about 500,000 to 800,000 cp. Solutions or preparations with lower viscosities, such as aqueous solutions and glycerin-based compositions can also be used. Generally, neutral pH gels are advantageous; however, the pH is preferably optimized to allow the ionized form of the medicament to exist at a sufficient concentration. For instance, suitable 0.9% NaF gels can be prepared at a pH ranging from about 3.0 to about 7.0. As another example, a viscous 5% potassium nitrate gel can be prepared at a pH of about 7.0.

Examples of medicants include tooth whiteners such as hydrogen peroxide, agents to treat dental sensitivity such as potassium nitrate and particulate bioglass such as Novamin® (calcium sodium phosphosilicate), glucocorticoids, antimicrobial agents such as antibiotics, antiviral agents, agents to remineralize teeth such as Novamin® and fluorides like sodium fluoride, sodium fluoride aqueous solution, potassium fluoride, and potassium fluoride aqueous solution, anti-inflammatory agents such as steroids, nitrates like potassium nitrate in aqueous solution, agents to block nerve conduction such as lidocaine and other topical anesthetics, and anti-inflammatory agents such as nonsteroidal anti-inflammatory drugs (NSAIDs) like naproxen and ibuprofen. Liposomes as drug or medicament carriers can also be used which offers the advantage of using poorly soluble drugs in combination with iontophoresis. More specific examples of fluoride medicaments include a gel of acidulated phosphate fluoride (11.23% [12,300 ppm] fluoride), a gel or a foam of sodium fluoride (0.9% [9,040 ppm] fluoride), a gel of sodium fluoride (0.5% [5,000 ppm] fluoride), and a gel of stannous fluoride (0.15% [1,000 ppm] fluoride).

A power supply 410 is configured to apply an appropriate current and voltage between the conductive layer 315 of the dental tray 300 and an electrode 415 in electrical contact with the person being treated. In some embodiments, the electrode 415 is in contact with the person's hand, for example. In the example shown in FIG. 4, the electrode 415 is in contact with soft tissue proximate to the tooth such as the gingiva. In various embodiments, the electrode 415 can comprise a metal strip or a conductive adhesive patch. In certain embodiments the dental tray 300 has the electrode 415 printed onto the outside surface of the dental tray 300 and/or onto the inside surface of the dental tray 300 but in an area electrically separated from the conductive layer 315. In this these embodiments, when the dental tray 300 is placed over the dental arch, the electrode 415 can contact the soft tissue proximate to the tissue to be treated. A specific example is illustrated in FIG. 15, described below.

The power supply 410 can apply DC, AC, or AC with a DC offset. In exemplary embodiments, a suitable ratio of the current relative to the conductive area of the electrode 415 is within a range of about 300 to 1500 mA/cm². In some of these embodiments the ratio is within a range of about 800 to 1200 mA/cm². In still further of these embodiments the ratio is about 500 mA/cm² or 1000 mA/cm². In various embodiments that employ AC, with or without a DC offset, a suitable frequency lies in the range of about 0.1 Hz to 1,000,000 Hz, for example 100,000 Hz. Suitable treatment times, in some embodiments, range from about 0.1 to about 60 minutes, but can also be in the range of about 1 to 30 minutes, or about 1 to 5 minutes.

The power supply 410 can be palm-sized in some embodiments. The power supply 410 can also comprise a microprocessor and be programmable, allowing a user to customize protocols. In some embodiments, the power supply 410 is configured to sense current, voltage, and resistance when coupled to the person being treated. For example, during constant current iontophoresis, when resistance increases due to polarization or a decrease in the number of available ions to conduct charge, the power supply 410 can respond by increasing the voltage to maintain the constant current through the oral tissues.

The power supply 410 shown in FIG. 4 is external to the dental tray 300, and can be, for example, a unit that plugs into a standard electrical outlet to operate off of power supplied by a generator or a municipal power grid. The external power supply 410 of FIG. 4 can also operate off of battery power, in some instances. Such power supplies 410 can be used in conjunction with both disposable and reusable dental trays 300. In further embodiments, the power supply 410 is integral with the dental tray 300 and comprises a battery. Some of these embodiments are particularly suitable for disposable applications.

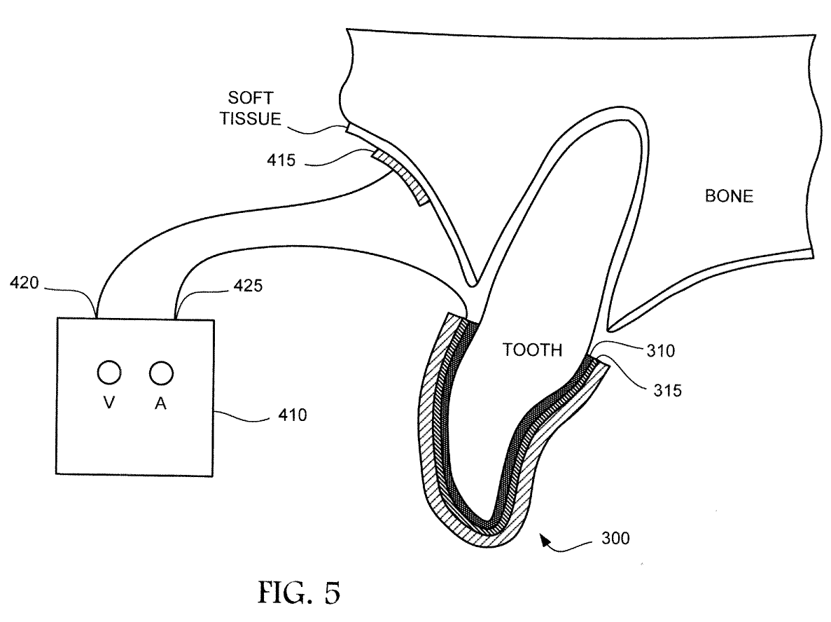

FIG. 5 illustrates another embodiment of the dental tray 300 in an exemplary use configuration disposed proximate to a tooth. In this embodiment, the dielectric layer 310 comprises a hydrogel layer. Here, the hydrogel of the dielectric layer 310 includes the medicament and makes contact with the tooth. Such contact is facilitated by swelling of the hydrogel that occurs as the hydrogel adsorbs water. As in FIG. 4, the power supply 410 is configured to apply an appropriate current and voltage between the conductive layer 315 of the dental tray 300 and the electrode 415 in electrical contact with the person being treated. As above, the power supply 410 can be external to, or integral with, the dental tray 300. In still other embodiments, the dielectric layer 310 can comprise a layer of compliant non-conductive foam that contains the medicament. Like a hydrogel, the foam can come preloaded with the medicament or the medicament can be added by the user, and the porosity of the foam provides openings for the transport of the medicament.

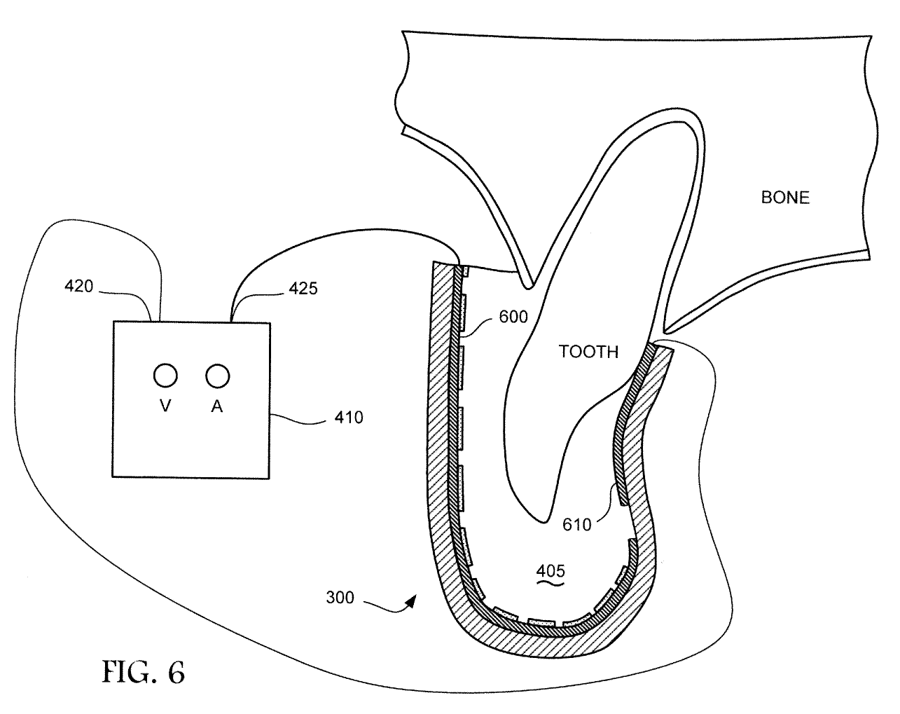

FIG. 6 illustrates another embodiment of the dental tray 300 in an exemplary use configuration disposed proximate to a tooth. In this embodiment, the conductive layer 315 is patterned into two portions, a first portion 600 and a second portion 610. The dielectric layer 310 is patterned over the first portion 600 of the conductive layer 315 to keep the first portion 600 from making contact with the tissue being treated. The dielectric layer 310 is omitted from the second portion 610 of the conductive layer 315 so that the second portion 610 can contact the tissue being treated, as shown. As in FIG. 4, the volume between the dental tray 300 and the tooth is filled with the medicament 405. In this embodiment, the power supply 410 is configured to apply an appropriate current and voltage between the first and second portions 600, 610 of the conductive layer 315. As above, the power supply 410 can be external to, or integral with, the dental tray 300.

The power supply 410 in FIGS. 4 and 5 includes a first terminal 420 electrically connected to the electrode 415 and a second terminal 425 electrically connected to the conductive layer 315. In the embodiment shown in FIG. 6, the first and second terminals 420, 425 are electrically connected to the second and first portions 610, 600 of the conductive layer 315, respectively. When a positive bias applied to the first terminal 420 and a negative bias applied to the second terminal 425 in FIGS. 4 and 5, negatively charged ions, for example fluoride ions, are repelled from the negatively charged conductive layer 315 and drawn towards the positively charged tooth. Similarly, when a positive bias applied to the first terminal 420 and a negative bias applied to the second terminal 425 in FIG. 6, negatively charged ions are repelled from the negatively charged first portion 600 of the conductive layer 315 and drawn towards the positively charged tooth.

With particular reference to FIG. 4, it will be appreciated that the conductive layer 315 can be patterned as shown in FIG. 1 rather than continuous as in FIG. 3. As previously discussed, in such an embodiment the conductive layer 315 would comprise a number of parallel traces running perpendicular to the plane of the drawing page. In one such embodiment, the traces disposed along the trough of the dental tray 300 can be at a first potential, such as 5 mV, while the traces disposed on opposite sides of the tooth nearer to the soft tissue can be at a second potential, such as 10 mV.

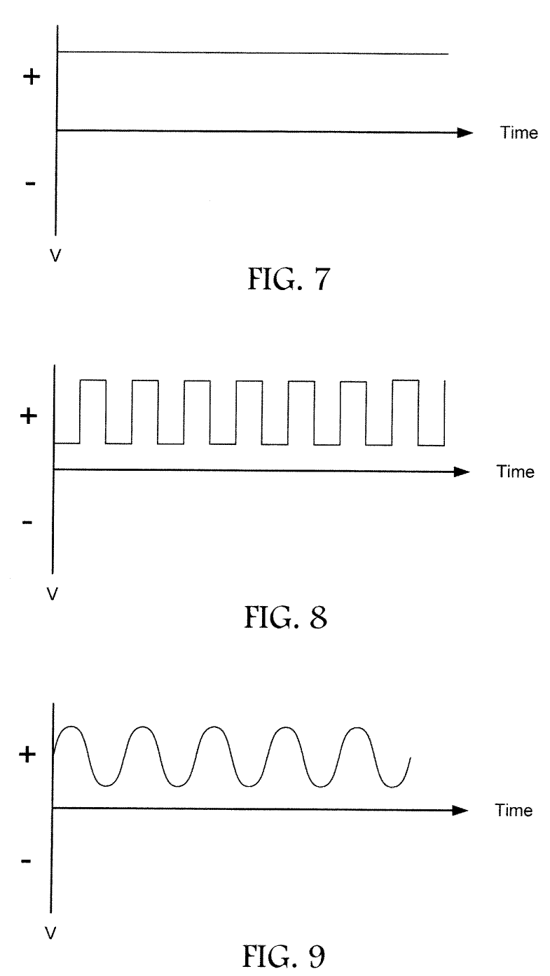

The power supply 410 may apply DC, AC, or AC with a DC offset. Examples of some suitable waveforms are shown in FIGS. 7-9. FIG. 7 shows a constant DC voltage applied between the first terminal 420 and the second terminal 425, while in FIGS. 8 and 9 an AC voltage with a DC offset is applied. In FIG. 8 the AC voltage has a square-wave waveform, while the waveform is sinusoidal in FIG. 9. Triangular and other waveforms can also be applied. In general, voltages up to about 5 V can be applied, and more specifically voltages in the range of about 10 mV to about 100 mV, or even more specifically 20 mV to 50 mV.

Although the DC offset in both of FIGS. 8 and 9 is greater than half of the amplitude of the respective waveforms, it will be appreciated that in some embodiments the DC offset can be less than half of the amplitude of the waveform such that the polarity of the applied voltage switches during a portion of each cycle. In some embodiments, the waveform comprises periodic high voltage pulses superimposed over a DC offset. It will also be understood that an AC voltage without a DC offset can be applied. Further, the polarity of the power supply 410 can be reversed from that shown in FIGS. 7-9 to drive positively charged ions towards the tooth.

The use of various AC waveforms to temporarily affect the porosity of biological materials is a technique sometimes referred to as electroporation. Tissues are porous strictures consisting of various material phases (e.g., cells, fibrous tissue, and minerals) with a charged perfusant. The porosity or effective pore size of some tissues can be increased by using high voltage pulses. Using such waveforms as described above can enhance delivery of medicaments via ion pumping, for instance. As one example, electroporation reversibly makes certain lipid bilayers more permeable by creating aqueous pores. From a bulk tissue perspective, using a pulsed or an AC waveform can effectively increase the mobility of a particular charged entity through the tissue.

A further advantage derived from electroporation and electric fields in general, as used herein, derives from the increased fluid flow or mass flow that occurs when certain tissues are subjected to various electrics fields. For example, gingival tissues, and in particular intra-pocket gingival tissues when subjected to electric fields and electroporation can be stimulated to produce increased gingival crevicular fluid flow or mass flow. Gingival crevicular fluid flows generally from the periodontal pocket into the oral cavity and fluids from the oral cavity can flow into the periodontal pocket. For the purposes of delivering a medicament into a periodontal pocket, the devices described herein induce bulk fluid flow or mass flow to increase from the periodontal pocket to the oral cavity simultaneous with the flow of medicament ions (mass flow) from such devices into the periodontal pocket. The net result is increased fluid (mass) and ion flow in both directions. Thus, by virtue of increasing the bi-directional fluid flow via the induced electric field and electroporation, improved delivery of medicaments into periodontal pockets is achieved.

Three specific examples of the use of the dental tray 300 will now be provided with reference to FIGS. 4 and 6. The first example employs a medicament comprising a viscous 0.9% NaF gel having a pH in the range of about 3.0 to about 7.0. The gel is dispensed into the trough of the dental tray 300 and placed over a patient's dental arch. The dental tray 300 is coupled to the power supply 410 such that the patient's body is positively charged and the conductive layer 315 (or the first portion 600 thereof in FIG. 6) is negatively charged. Fluoride ion pumping into the teeth occurs when, for example, a frequency of 5,000 Hz is used in combination with a full or partial negative DC offset. The application can be applied for 5 minutes or less. A constant DC current of 0.2 mA can be applied for 2 minutes (0.06 Coulombs). As another example, an AC current of 0.05 mA with a full DC offset at a frequency of 120 Hz can be applied for 2 minutes.

A second example is directed to the use of iontophoresis to effectively deliver potassium ions to nerve cells. In this example, a medicament comprising a viscous 5% potassium nitrate gel is prepared at a pH of about 7.0. The gel is dispensed into the trough of the dental tray 300 and placed over the patient's dental arch. The conductive layer 315 (or the first portion 600 thereof in FIG. 6) of the dental tray 300 is positively charged while the patient's body is negatively charged. Potassium ion pumping occurs when, for example, a frequency of 5,000 Hz is used in combination with a full or partial positive DC offset. The application can be applied for 5 minutes or less. A constant DC current of 0.2 mA can be applied for 2 minutes (0.06 Coulombs). As another example, an AC current of 0.05 mA with a full DC offset at a frequency of 120 Hz can be applied for 2 minutes. Both of the two examples above can be modified to correspond to the embodiment shown in FIG. 5 by employing a hydrogel or foam including the medicament in place of a patterned dielectric layer 310, rather than adding a gel including the medicament into the trough of the dental tray 300.

In a third example, a paste including Novamin® is dispensed into the trough of the dental tray 300 and the dental tray is applied as described in the prior two examples. The iontophoresis serves to accelerate the rate of calcium hydroxyapatite deposition to more rapidly occlude pores in tooth enamel. This, in turn, can lead to a more rapid decrease in sensitivity.

Like the full dental tray 300, another embodiment directed to a half-tray or strip appliance can also be used. For example, the strip appliance can comprise a dental tray that covers essential just the facial surfaces of the teeth. The strip appliance, like the dental tray 300, can be flexible and comprise an outer dielectric layer 305, an inner dielectric layer 310, and a conductive layer 315 disposed between the outer and inner dielectric layers 305 and 310. As above, the dielectric layer 310 can be patterned or can comprise a hydrogel. For fluoride treatment, in those embodiments in which the dielectric layer 310 does not comprise a hydrogel, a NaF gel is dispensed on the dielectric layer 310 and formed to the facial surfaces of the teeth. Alternatively, the dielectric layer 310 can be a hydrogel comprising NaF or a foam layer comprising a liquid or gel comprising NaF. Operation of the strip appliance can be the same as described above with respect to the dental tray 300. In further embodiments, the strip appliance can include the complete outer dielectric layer 305 of the full dental tray 300 but the inner patterned dielectric layer 310 and the conductive layer 315 are disposed on only one surface, for example, the facial surface of the dental tray.

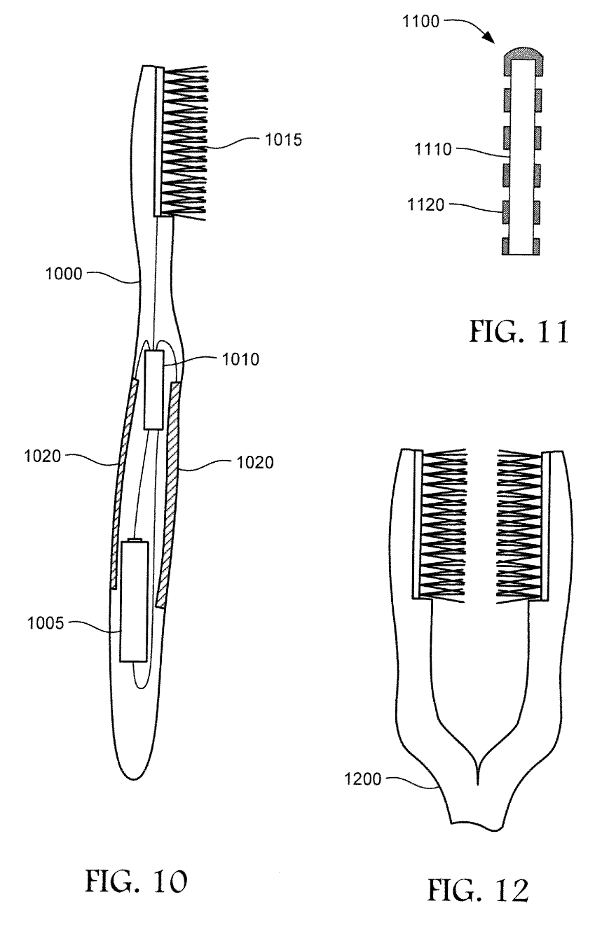

FIG. 10 shows a cross-sectional view of an exemplary toothbrush 1000. The toothbrush 1000 comprises a battery 1005 in electrical communication with a control circuit 1010 configured to apply a voltage between conductive bristles 1015 and one or more conductive pads 1020 disposed on an exterior surface of the toothbrush 1000. In various embodiments, some or all of the bristles of the toothbrush 1000 comprise conductive bristles 1015. In various embodiments, the number of conductive bristles 1015 is 20, 50, 100, 200, 300, 400, or 500. In various embodiments, the bristles are arranged in tufts, and the number of conductive bristles 1015 per tuft is 1, 2, 3, 5, 10, 15, 20, 25, 30, 35, 40, 45, or 50. When a user grasps the toothbrush 1000, the one or more conductive pads 1020 make electrical contact with the user's hand, making the user electrically charged relative to the conductive bristles 1015. In some embodiments, the battery 1005 also serves to power a motor (not shown) that vibrates the bristles.

FIG. 11 shows an enlarged cross-sectional view of an exemplary conductive bristle 1100. The conductive bristle 1100 comprises an electrically conductive core 1110 surrounded by a patterned dielectric layer 1120 that serves to keep the conductive core 1110 from contacting the tissue to be treated, much as the inner dielectric layer 310 serves to keep the conductive layer 315 from contacting the tissue to be treated in FIG. 3. The conductive core 1110 can comprise gold, carbon, platinum, silver, copper, or a conductive polymer, for example. Examples of conductive polymers include organic polymer semiconductors, and/or organic semiconductors, for example conductive polymers from either of the two classes of charge transfer complexes or conductive polyacetylenes. The latter include polyacetylene itself as well as polypyrrole, polyaniline, and their derivatives. Hitech Polymers of Hebron Ky., USA, for example provides a full line of conductive polymers. In some embodiments, the conductive core 1110 is co-extruded along with the dielectric layer 1120. In other embodiments the dielectric layer 1120 is extruded over a previously formed, for example by extrusion or drawing, conductive core 11110. In some embodiments the conductive core 1110 is formed by sputter coating onto a flexible inner fiber (not shown). In other embodiments the conductive core 1110 is formed by plating the conductive material onto the flexible inner fiber. In still other embodiments the conductive layer is applied in the form of a liquid, for example as a conductive suspension or ink, to the flexible inner fiber. The dielectric layer 1120 can comprise, for example, a layer of fluorinated ethylene-propylene (FEP). In some embodiments, the dielectric layer 1120 is patterned, with holes and then fused over the conductive core 1110. In other situations the dielectric layer 1120 is first bonded over the conductive core 1110, masked, and then etched to produce a pattern of openings.

In still other embodiments, the dielectric layer 1120 is porous. The porosity in these embodiments can be filled with a medicament or a hydrogel including the medicament. Here, the brush may be used for a single application of the medicament before being discarded. In such embodiments the brush is pre-loaded to deliver a pre-measured amount of the medicament. In addition to such single-use disposable toothbrushes 1000, some embodiments are directed to short duration use where the amount of medicament is sufficient to last for 5 days or a week, for example.

The toothbrush 1000 functions in a manner similar to the dental tray 300 described above. A medicament is applied to the bristles of the toothbrush 1000, in the form of a toothpaste for example, and brushed against the teeth. The voltage applied by the control circuit 1010 between the user and the conductive bristles 1015 serves to drive the medicament into the teeth. All of the various waveforms and ranges for voltage and current described above with respect to the dental tray 300 are also applicable to the toothbrush 1000. FIG. 12 illustrates still another embodiment in which a toothbrush 1200 comprises two opposing heads each including conductive bristles as described above.

In various embodiments the toothbrush 1000 is designed to be used with a specific medicament and the control circuit 1010 is Configured to apply a single preset configuration comprising the appropriate polarity, voltage, current, DC offset, etc. Some of these embodiments are directed to single-use or short duration use toothbrushes 1000 described above. In other embodiments, the user can change the settings of the control circuit 1010 to allow for the application of different medicaments. In further embodiments, the power supply (e.g., power supply 410) is external to the toothbrush 1000 and is electrically coupled between the toothbrush 1000 and an electrode (e.g., electrode 415) adhered to the user.

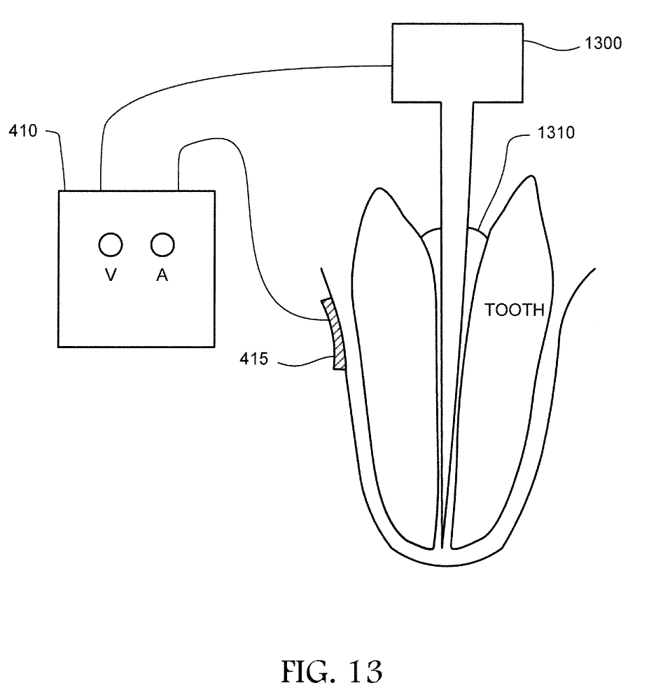

FIG. 13 shows a cross-sectional view of an endofile 1300 disposed down into a root of a tooth, for example, during root canal surgery. A medicament 1310 comprising an anesthetic, and/or antimicrobial, and/or antifungal, for instance, is disposed down into the root. A power supply 410 electrically coupled between the endofile 1300 and an electrode 415 is used, as described above, to drive the medicament 1310 into the tooth. The endofile 1300 can comprise an electrically conductive core (not shown) surrounded by a patterned dielectric layer (not shown) that serves to keep the conductive core from contacting the tooth being treated, much as described above with respect to the dental tray and toothbrush embodiments. All of the various waveforms and ranges for voltage and current described above with respect to the dental tray 300 are also applicable to the endofile 1300. Similar to the toothbrush 1000 described above, the dielectric layer can be porous and include the medicament, or a hydrogel including the medicament, within the pores. Thus, the endofile 1300 can be a single-use disposable device with a pre-measured amount of the medicament, as previously described. Methods discussed above with respect to the construction of conductive bristles 1100 apply equally to the endofile 1300.

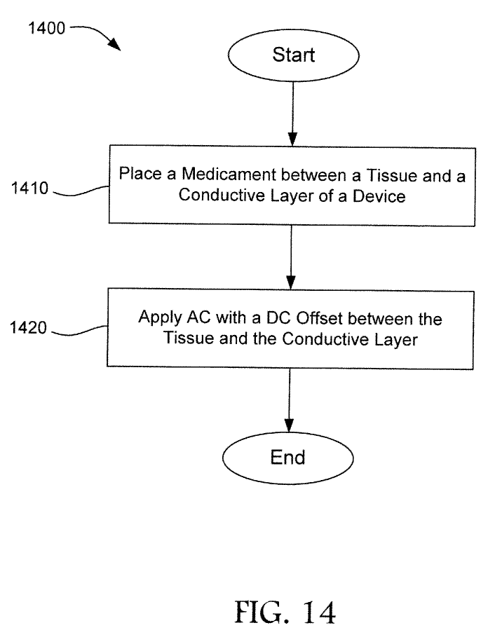

FIG. 14 illustrates an exemplary method 1400 for delivering a medicament into tissue, such as hard and soft tissues of the oral cavity. The method 1400 comprises the step 1410 of placing the medicament between the tissue and a conductive layer of a device, and the step 1420 of applying AC current with a DC offset between the tissue and the conductive layer.

One suitable device for use in the method 1400 is a dental tray, such as dental tray 300, or a strip appliance described above. In these embodiments, step 1410 can comprise placing the dental tray or strip appliance over a dental arch. Where the dielectric layer 310 of the dental tray or strip appliance comprises a patterned material, step 1410 can also comprise filling a trough of the dental tray or strip appliance with the medicament before placing the dental tray or strip appliance over the dental arch.

Another suitable device for use in the method 1400 is a toothbrush, such as toothbrush 1000 described above. In these embodiments, step 1410 can comprise applying a toothpaste including the medicament to the toothbrush and then brushing the teeth with the toothbrush. Yet another suitable device for use in the method 1400 is an endofile, such as the endofile 1300 described above. Here, the medicament can comprise an agent to block nerve conduction, for instance, and step 1410 can comprise applying the agent to a tooth.

For any of the devices described herein, where the dielectric layer 310 includes a hydrogel, the hydrogel may not include the medicament at the time of manufacture. Instead, the medicament is applied to the hydrogel shortly before the device is to be used. The medicament can be sprayed onto the hydrogel surface, or the device can be immersed into a solution comprising the medicament for a predetermined length of time. In this way, shortly before use, the hydrogel takes up the medicament. These embodiments can be advantageous where the medicament may not have a long shelf-life, for example.

For various devices, the step 1420 can include attaching an electrode to the person being treated. The step 1420 can also include applying about 300 to 1500 mA/cm² in some embodiments. In various embodiments, step 1420 includes applying DC current of about 0.2 mA or applying AC current of about 0.05 mA.

FIG. 15 illustrates an embodiment of the dental tray 300 has the electrode 415 disposed on the outside surface 1500 of the dental tray 300. In this example, the electrode 415 extends over the lip of the dental tray 300 and onto the inside surface 1510 of the dental tray 300. Where the electrode 415 is disposed on the inside surface 1510, the electrode 415 is electrically insulated from the conductive layer 315. In FIG. 15, the inner dielectric layer has been omitted for clarity. In this embodiment, when the dental tray 300 is placed over the dental arch, the electrode 415 contact the soft tissue proximate to the tissue to be treated. Also shown in FIG. 15 is an extension 1520 of the dental tray 300 that constitutes an integral power supply. This power supply includes a battery 1530 and a control circuit 1540. The control circuit 1540 is in electrical communication with the battery 1530, the electrode 415, and the conductive layer 315, and is configured to apply AC current with a DC offset between the electrode 415 and the conductive layer 315.

In the foregoing specification, the present invention is described with reference to specific embodiments thereof, but those skilled in the art will recognize that the present invention is not limited thereto. Various features and aspects of the above-described present invention may be used individually or jointly. Further, the present invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

1. A system comprising:
a conductive layer;
a dielectric layer disposed over the conductive layer, the dielectric layer including openings;
an electrode; and
a power supply configured to apply AC with a DC offset between the conductive layer and the electrode.

2. The system of claim 1 wherein the conductive layer is patterned.

3. The system of claim 1 wherein the electrode includes a metal strip.

4. The system of claim 1 wherein the electrode includes a conductive adhesive patch.

5. The system of claim 1 wherein the power supply comprises a battery.

6. The system of claim 1 further comprising a dielectric substrate wherein the conductive layer is disposed between the dielectric substrate and the dielectric layer.

7. The system of claim 6 wherein the dielectric substrate comprises polyimide.

8. The system of claim 6 wherein the dielectric substrate comprises a dental tray.

9. The system of claim 1 further comprising a toothbrush, wherein a bristle of the toothbrush comprises the conductive and dielectric layers.

10. The system of claim 1 wherein an endo fie comprises the conductive and dielectric layers.

11. The system of claim 1 wherein the dielectric layer comprises a hydrogel.

12. The system of claim 1 wherein the dielectric layer comprises a foam.

13. The system of claim 1 wherein the dielectric layer comprises fluorinated ethylene-propylene patterned with openings.

14. A dental tray comprising:
a dielectric substrate formed to have a trough and to approximate the curvature of a dental arch;
a dielectric layer conforming to the dielectric substrate and including openings; and
a conductive layer disposed between the dielectric substrate and the dielectric layer.

15. The dental tray of claim 14 further comprising a medicament disposed within the trough.

16. The dental tray of claim 14 further comprising a power supply configured to generate AC with a DC offset.

17. The dental tray of claim 16 wherein the power supply includes a battery.

18. The dental tray of claim 14 wherein the dielectric layer comprises a hydrogel.

19. The dental tray of claim 14 wherein the dielectric layer comprises a pattern of openings.

20. The dental tray of claim 14 wherein the conductive layer comprises a pattern.

21. A toothbrush comprising:
a conductive pad disposed on an exterior surface;
a plurality of conductive bristles each including an electrically conductive core surrounded by a patterned dielectric layer;
a battery;
a control circuit in electrical communication with the battery, the conductive pad, and the plurality of conductive bristles and configured to apply a voltage between the conductive pad and the conductive bristles.

22. The toothbrush of claim 21 wherein the control circuit is configured to apply DC between the conductive pad and the conductive bristles.

23. The toothbrush of claim 21 wherein the control circuit is configured to apply AC with a DC offset between the conductive pad and the conductive bristles.

24. A method for delivering a medicament into tissue, the method comprising:
placing the medicament between the tissue and a conductive layer of a device; and
applying AC with a DC offset between the tissue and the conductive layer.

25. The method of claim 24 wherein the device comprises a dental tray and placing the medicament between the tissue and the conductive layer includes placing the dental tray over a dental arch.

26. The method of claim 25 further comprising filling a trough of the dental tray with the medicament.

27. The method of claim 25 wherein the dental tray includes a hydrogel layer disposed over the conductive layer and including the medicament.

28. The method of claim 24 wherein the device comprises a toothbrush and the method further comprises applying a toothpaste including the medicament to the toothbrush.

29. The method of claim 24 wherein the device comprises an endofile, the medicament comprises an agent to block nerve conduction, and the method further comprises applying the agent to a tooth.

30. The method of claim 24 wherein applying AC with a DC offset between the tissue and the conductive layer includes attaching an electrode to the person being treated.

31. The method of claim 24 wherein applying AC with a DC offset between the tissue and the conductive layer includes applying about 300 to 1500 mA/cm².

32. The method of claim 24 wherein applying AC with a DC offset between the tissue and the conductive layer includes applying DC current of about 0.2 mA.

33. The method of claim 24 wherein applying AC with a DC offset between the tissue and the conductive layer includes applying AC current of about 0.05 mA.
